(19) United States
(12) Patent Application Publication
(10) Pub. No.: US 2025/0357782 A1
(43) Pub. Date: Nov. 20, 2025

(54) ENERGY STORAGE CIRCUITS FOR UNINTERRUPTIBLE POWER SUPPLIES (UPSS) AND RELATED UPSS

(71) Applicant: Santak Electronic (Shenzhen) Co., Ltd., Shenzhen (CN)

(72) Inventors: Dawei Zheng, Shenzhen (CN); Lei Cao, Shenzhen (CN); Yulong Hao, Shenzhen (CN); Dan Liu, Shenzhen (CN)

(21) Appl. No.: 19/196,942

(22) Filed: May 2, 2025

(30) Foreign Application Priority Data
May 17, 2024 (CN) 202421079507.6

(51) Int. Cl. H02J 9/06; H02M 5/458

(52) U.S. Cl. CPC H02J 9/062; H02M 5/458

(57) ABSTRACT

An energy storage circuit for an uninterruptible power supply (UPS) includes: a first converter unit, connected between a positive DC bus and a ground, and used to receive AC power from an external power supply, rectify and boost the AC power, and supply power to the positive DC bus; a second converter unit used to receive the AC power from the external power supply, rectify and boost AC power, and supply power to the negative DC bus; a first energy storage device used to store electrical energy from the first converter unit; a second energy storage device used to store electrical energy from the second converter unit; and an inverter for receiving electrical energy from the DC bus and inverting the electrical energy into AC power and outputting the AC power to a load. The first and second energy storage devices each include a plurality of capacitors connected in parallel.

### CROSS-REFERENCE TO RELATED APPLICATION

This application claims priority to Chinese Patent Application No. 202421079507.6, filed May 17, 2025, the content of which is hereby incorporated herein by references in its entirety.

### FIELD

The present inventive concept relates generally to the field of uninterruptible power supplies and, in particular, to an energy storage circuit for an uninterruptible power supply and an uninterruptible power supply.

### BACKGROUND

An Uninterruptible Power Supply (UPS) is an alternating circuit (AC) power supply with an energy storage device, and can provide uninterruptible power supply to a load during power outage by means of the energy storage device. The uninterruptible power supply usually uses a battery as a backup power supply, and requires an independent battery boost circuit. Especially in a three-phase UPS, a higher bus voltage is needed, and therefore, more batteries connected in series or a higher-power battery boost circuit is needed, which increases the energy consumption and cost of the uninterruptible power supply.

### SUMMARY

Some embodiments of the present inventive concept provide an energy storage circuit for an uninterruptible power supply, including: a first converter unit, connected between a positive DC bus and a ground, and used to receive an AC power from an external power supply, rectify and boost the AC power, and then supply power to the positive DC bus; a second converter unit, connected between a negative DC bus and the ground, and used to receive the AC power from the external power supply, rectify and boost the AC power, and then supply power to the negative DC bus; a first energy storage device, connected between the positive DC bus and the ground, and used to store electrical energy from the first converter unit; a second energy storage device, connected between the negative DC bus and the ground, and used to store electrical energy from the second converter unit; and an inverter for receiving electrical energy from the DC bus and inverting the electrical energy into AC power and outputting the AC power to a load. The first energy storage device and the second energy storage device each include a plurality of capacitors connected in parallel.

In some embodiments, the capacitors are electrolytic capacitors with withstand voltage values higher than a peak value of the external power supply.

In further embodiments, an overall capacity value of the first energy storage device and the second energy storage device is expressed as:

$$C > \frac{2 PT}{{U}^{2} \cdot {E}_{eff}}$$

wherein C is the overall capacity value of the first energy storage device and the second energy storage device, U is a voltage between the positive DC bus and the negative DC bus, P is an output power of the uninterruptible power supply, T is power backup time, and Eeff is an efficiency of the uninterruptible power supply.

In still further embodiments, the energy storage circuit further includes a discharging circuit configured to discharge the first energy storage device and the second energy storage device when the uninterruptible power supply is powered off.

In some embodiments, the discharging circuit includes a first resistor, a second resistor and a switching device, the switching device includes a power supply end connected to an internal power supply of the uninterruptible power supply, a first switch and a second switch, the switching device is used to turn off the first switch and the second switch when the internal power supply is on a high level, and turn on the first switch and the second switch when the uninterruptible power supply is powered off and the internal power supply is reduced to be lower than a threshold; and the positive DC bus is connected to the ground via the first resistor and the first switch, and the negative DC bus is connected to the ground via the second resistor and the second switch.

In further embodiments, the switching device is a relay, a circuit breaker, a mechanical switch or a semiconductor switch.

In some embodiments, the energy storage circuit further includes a discharge completion indicating circuit for indicating that the first energy storage device and the second energy storage device complete discharge.

In further embodiments, the discharge completion indicating circuit includes a third resistor, a voltage stabilizing diode and a light emitting diode that are connected in series between the positive DC bus and the negative DC bus.

In some embodiments, the first converter unit and the second converter unit each include a rectifying unit and a boosting unit, and the boosting unit is a flyback circuit.

Further embodiments of the present inventive concept provide an uninterruptible power supply, including the above-mentioned energy storage circuit for an uninterruptible power supply, and the uninterruptible power supply storing electrical energy by only using the energy storage circuit.

By using the energy storage circuit and the uninterruptible power supply in accordance with embodiments discussed herein, batteries and connecting lines of the batteries are saved, and the cost is reduced. By using the capacitors, the charging current can be greater, the charging speed can be higher, and the load can be protected better.

### BRIEF DESCRIPTION OF THE DRAWINGS

FIG. 1 shows a schematic diagram of an energy storage circuit for an uninterruptible power supply according to some embodiments of the present inventive concept.

FIG. 2 shows a circuit diagram of an energy storage circuit for an uninterruptible power supply according to some embodiments of the present inventive concept.

FIG. 3 shows a schematic diagram of an automatic discharging circuit according to some embodiments of the present inventive concept.

FIG. 4 shows a schematic diagram of a discharge completion indicating circuit according to some embodiments of the present inventive concept.

FIG. 5 shows a schematic diagram of an uninterruptible power supply according to some embodiments of the present inventive concept.

FIG. 6 shows a schematic diagram of an uninterruptible power supply according to some embodiments of the present inventive concept.

### DETAILED DESCRIPTION

In order to make objects, technical solutions and advantages of the disclosure clearer and more understandable, the disclosure will be further described in detail below in conjunction with the accompanying drawings and specific embodiments. It should be noted that the embodiments given in the disclosure are only for the purpose of description, rather than limiting the protective scope of the disclosure.

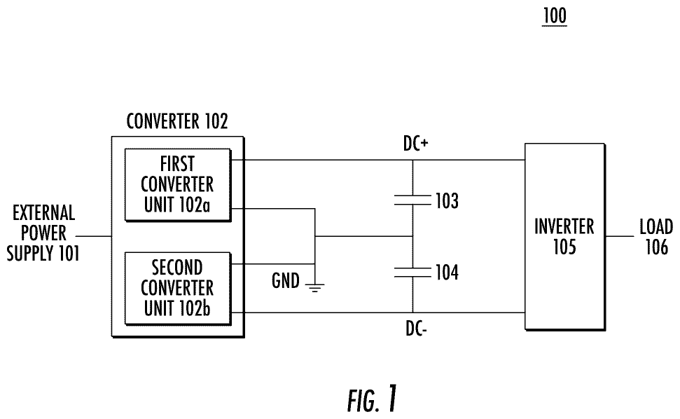

FIG. 1 shows a schematic diagram of an energy storage circuit for an uninterruptible power supply according to some embodiments of the present inventive concept. As shown in FIG. 1, the energy storage circuit 100 is connected between an external power supply 101 of the uninterruptible power supply and a load 106. The energy storage circuit 100 includes a converter 102, used to receive an AC power from the external power supply 101, rectify and boost the AC power, and then supply power to a DC bus; a first energy storage device 103, connected between a positive DC bus DC+ and a ground GND, and used to store electrical energy from the converter 102; a second energy storage device 104, connected between a negative DC bus DC− and the ground, and used to store the electrical energy from the converter 102; and an inverter 105 for receiving electrical energy from the DC bus and inverting the electrical energy into AC power and outputting the AC power to the load 106.

In an embodiment, the converter 102 includes a first converter unit 102a, connected between the positive DC bus DC+ and the ground and used to receive the AC power from the external power supply, rectify and boost the AC power, and then supply power to the positive DC bus DC+; and a second converter unit 102b, connected between the negative DC bus DC− and the ground, and used to receive the AC power from the external power supply, rectify and boost the AC power, and then supply power to the negative DC bus DC−. The first converter unit 102a and the second converter unit 102b can independently charge the first energy storage device 103 and the second energy storage device 104, respectively. In an embodiment, the first converter unit 102a and the second converter unit 102b can be isolated or non-isolated.

The first energy storage device 103 includes a plurality of capacitors connected in parallel, and the second energy storage device 104 includes a plurality of capacitors connected in parallel. In an embodiment, the capacitors have higher withstand voltage values, for example, the withstand voltage values are higher than a peak value of the external power supply. In an embodiment, the withstand voltage values of the capacitors are higher than 450 V, for example, the withstand voltage values can be 550 V.

In an embodiment, the capacitors are built into the interior of the uninterruptible power supply.

In an embodiment, the capacitors are electrolytic capacitors. In the energy storage circuit for the uninterruptible power supply, backup batteries are replaced with the electrolytic capacitors, so that batteries and connecting lines of the batteries are saved, and the cost is reduced. By using the capacitors, the charging current can be greater, the charging speed can be higher, and the load can be protected better.

The number and capacities of the capacitors can be selectively designed according to power backup time and an output power. An overall capacity value of the first energy storage device and the second energy storage device (i.e., an overall capacity value between the positive DC bus and the negative DC bus) may be calculated by the following formula (1):

$$C > \frac{2 PT}{{U}^{2} \cdot {E}_{eff}} \qquad ( 1 )$$

wherein C is the overall capacity value of the first energy storage device and the second energy storage device, U is a voltage between the positive DC bus and the negative DC bus, P is an output power of the uninterruptible power supply, T is the power backup time, and Eeff is an efficiency of the uninterruptible power supply.

In an embodiment, in the case that no other energy storage devices are externally connected, according to the overall capacity value of the first energy storage device and the second energy storage device, the uninterruptible power supply can achieve full-power backup operation for 100 ms or above.

In an embodiment, for a 15 kVA three-phase backup uninterruptible power supply, 30 electrolytic capacitors with a capacity value of 1800 uF and a withstand voltage value of 450 V are needed at each of positive and negative sides within the power backup time of 1 s.

In an embodiment, the external power supply 101 is a mains supply.

Charging and discharging modes of the energy storage circuit for an uninterruptible power supply shown in FIG. 1 are shown as follows. In the charging mode, the first energy storage device 103 and the second energy storage device 104 are charged by electrical energy of the external power supply 101 by means of the converter 102. In the discharging mode, electrical energy of the first energy storage device 103 and electrical energy of the second energy storage device 104 are used to be outputted to the inverter 105 to supply power to the load 106.

FIG. 2 shows a circuit diagram of an energy storage circuit for an uninterruptible power supply according to some embodiments of the present inventive concept. FIG. 2 shows specific circuits of a converter and an inverter. A converter 202 includes a first converter unit and a second converter unit. The first converter unit includes a first rectifying unit 207a, used to receive AC power from a first external power supply 201a, rectify the AC power into a DC power, and then output the DC power; and a first boosting unit 208a, used to receive the DC power from the first rectifying unit 207a, boost the DC power, and then output the DC power to the positive DC bus DC+. The second converter unit includes a second rectifying unit 207b, used to receive AC power from a second external power supply 201b, rectify the AC power into a DC power, and then output the DC power; and a second boosting unit 208b, used to receive the DC power from the second rectifying unit 207b, boost the DC power, and then output the DC power to the negative DC bus DC−.

As shown in FIG. 2, the first boosting unit 208a and the second boosting unit 208b each are flyback circuits. The first boosting unit 208a includes a switch tube Q1, a transformer T1 and a diode D1, wherein a primary side of the transformer T1 is connected to the first rectifying unit 207a, a secondary side thereof is connected between the positive DC bus DC+ and the ground, the switch tube Q1 is connected to the primary side of the transformer T1, and the diode D1 is connected between the secondary side of the transformer T1 and the positive DC bus DC+. The second boosting unit 208b includes a switch tube Q2, a transformer T2 and a diode D2, wherein a primary side of the transformer T2 is connected to the second rectifying unit 207b, a secondary side thereof is connected between the negative DC bus DC− and the ground, the switch tube Q2 is connected to the primary side of the transformer T2, and the diode D2 is connected between the secondary side of the transformer T2 and the negative DC bus DC−.

The inverter 205 includes a switch tube Q3 and a switch tube Q4 connected in series between the DC buses, a diode D3 antiparallel to the switch tube Q3 and a diode D4 antiparallel to the switch tube Q4, one end of an inductor LI is connected between the switch tube Q3 and the switch tube Q4, the other end thereof is connected to a capacitor C1, and the other end of the capacitor C1 is connected to the ground. The inverter 205 is connected to a load 206 by a switch S1.

Although the above-mentioned embodiments show that the first boosting unit 208a and the second boosting unit 208b each are flyback circuits, the disclosure is not limited thereto, and the first boosting unit 208a and the second boosting unit 208b can be any boosting circuits known in the art. Similarly, the inverter 205 can also be any inverter circuit known in the art. The first rectifying unit 207a and the second rectifying unit 207b can be any rectifying circuits known in the art.

Although it is shown in the above-mentioned embodiments that two external power supplies are provided, it should be understood by the skilled in the art that the first rectifying unit 207a and the second rectifying unit 207b can also be connected to the same external power supply as required.

When the uninterruptible power supply fails and needs to be maintained, the first energy storage device and the second energy storage device also need to be discharged by a discharging circuit (not shown in FIG. 1) to guarantee the safety of maintenance personnel. The first energy storage device and the second energy storage device can be discharged by any discharging circuit known in the art.

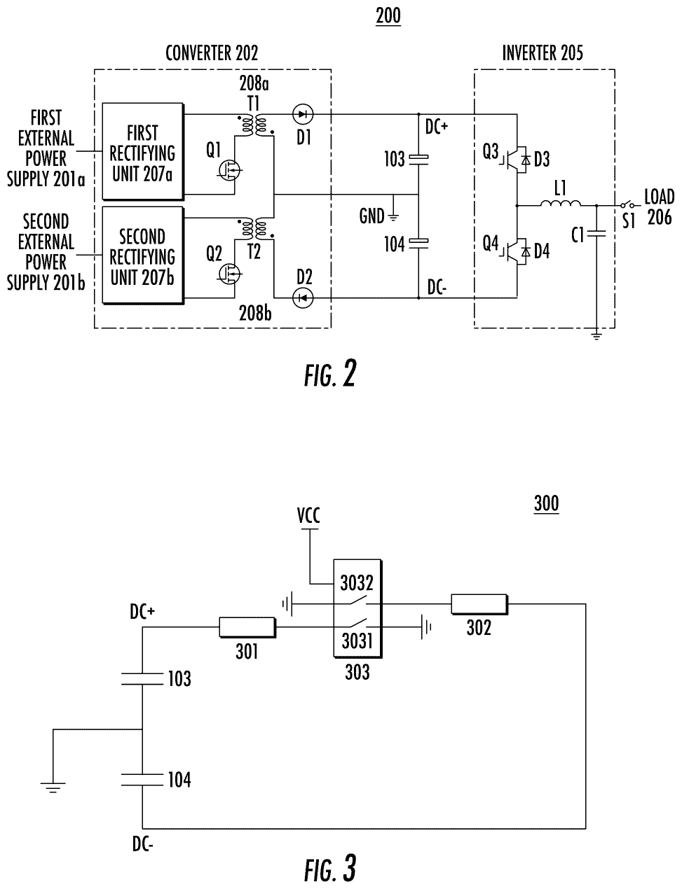

FIG. 3 shows a schematic diagram of an automatic discharging circuit according to some embodiments of the present inventive concept. In conjunction with FIG. 1 and FIG. 3, the automatic discharging circuit 300 includes a first resistor 301, a second resistor 302 and a switching device 303. The switching device 303 includes a power supply end connected to an internal power supply VCC (such as 24 V) of the uninterruptible power supply, a first switch 3031 and a second switch 3032, the switching device 302 is used to turn off the first switch 3031 and the second switch 3032 when the internal power supply VCC is on a high level, and turn on the first switch 3031 and the second switch 3032 when the uninterruptible power supply is powered off and the internal power supply VCC is reduced to be lower than a threshold (such as a low level). The positive DC bus DC+ is connected to the ground via the first resistor 301 and the first switch 3031, and the negative DC bus DC− is connected to the ground via the second resistor 302 and the second switch 3032.

In an embodiment, the internal power supply VCC is connected to a control panel inside the uninterruptible power supply.

When the uninterruptible power supply normally works, the internal power supply VCC is on the high level (such as 24 V), at the time, the switching device 303 is turned off, that is, the first switch 3031 and the second switch 3032 are turned off, and the first energy storage device 103 and the second energy storage device 104 do not discharge. When the uninterruptible power supply is powered off, the internal power supply VCC is reduced to be lower than the threshold (such as 0 V), at the time, the switching device 303 is turned on, that is, the first switch 3031 and the second switch 3032 are turned on, and the first energy storage device 103 and the second energy storage device 104 discharge.

In an embodiment, the switching device 303 is a relay, a circuit breaker, a mechanical switch or a semiconductor switch, etc. In an embodiment, the switching device 303 is a normally closed relay.

In an embodiment, values of the first resistor 301 and the second resistor 302 can be calculated according to required discharging time.

In an embodiment, the internal power supply VCC is located on the control panel of the uninterruptible power supply, and when the control panel of the uninterruptible power supply is powered off, the internal power supply VCC is reduced to 0 V.

In this embodiment, the uninterruptible power supply is powered off, which means that the uninterruptible power supply is disconnected with the outside (including the external power supply and the load). In an embodiment, the uninterruptible power supply is powered off, which includes situations that the uninterruptible power supply is powered off when failing, and the uninterruptible power supply is powered off during normal maintenance.

In order to guarantee the safety of the maintenance personnel, a discharge completion indicating circuit is further required for indicating that the first energy storage device and the second energy storage device complete discharge. Any indicating circuit known in the art can be used to indicate that the first energy storage device and the second energy storage device complete discharge.

FIG. 4 shows a schematic diagram of a discharge completion indicating circuit according to some embodiments of the present inventive concept. In conjunction with FIG. 1 and FIG. 4, the discharge completion indicating circuit 400 includes a third resistor 401, a voltage stabilizing diode 402 and a light emitting diode 403 that are connected in series between the positive DC bus DC+ and the negative DC bus DC−. The cathode of the voltage stabilizing diode 402 is connected to the resistor 401, the anode thereof is connected to the anode of the light emitting diode 403, and the cathode of the light emitting diode 403 is connected to the negative DC bus DC−. The voltage stabilizing diode 402 is used for stabilizing a voltage and limiting a current to avoid damaging the light emitting diode 403. In an embodiment, the resistor 401 has the resistor of 50 kΩ. When the positive DC bus DC+ and the negative DC bus DC− complete discharge, the light emitting diode 403 is turned off, which indicates that the discharge is completed.

FIG. 5 shows a schematic diagram of an uninterruptible power supply according to some embodiments of the present inventive concept. As shown in FIG. 5, the uninterruptible power supply 500 includes the energy storage circuit shown in FIG. 1. The uninterruptible power supply 500 includes a converter 502, with an input end being connected to an external power supply 501 by an internal input switch 508, and an output end being connected to a DC bus DC; an energy storage device 503 (including a first energy storage device and a second energy storage device), connected between the DC bus DC and a ground; an inverter 505, with an input end being connected to the DC bus DC, and an output end being connected to a first end of an inverter switch 509; a bypass switch 507 connected between the input end of the converter 502 and a second end of the inverter switch 509; and a first maintenance switch 510 used to selectively connect one of the external power supply 501 and the second end of the inverter switch 509 to a load 506. The energy storage device 503 includes a plurality of capacitors connected in parallel.

A working mode of the uninterruptible power supply 500 will be described below with a backup power supply as an example.

When the external power supply 501 normally works, the internal input switch 508 is turned on, the bypass switch 507 is turned on, the inverter switch 509 is turned off, and the first maintenance switch 510 is connected to the second end of the inverter switch 509. Electrical energy is directly outputted from the power supply 501 to the load 506 by a bypass. At the same time, the energy storage device 503 is in a charging mode, and the energy storage device 503 is charged by electrical energy from the external power supply 501 by a converter.

When the external power supply 501 is abnormal, the internal input switch 508 is turned off, the bypass switch 507 is turned off, the inverter switch 509 is turned on, and the first maintenance switch 510 is connected to the second end of the inverter switch 509. The energy storage device 503 is in a discharging mode, the electrical energy is outputted from the energy storage device 503 to the load 506 by the inverter 505.

When the UPS needs to be maintained, the first maintenance switch 510 is connected to the external power supply 501, at the time, the uninterruptible power supply does not work. The internal input switch 508 is turned off, the bypass switch 507 is turned off, the inverter switch 509 is turned off, and the energy storage device 503 begins to discharge.

In this embodiment, when maintenance is required, the first maintenance switch 510 needs to be switched, and an action of the first maintenance switch 510 may be delayed, so that the switching time is longer.

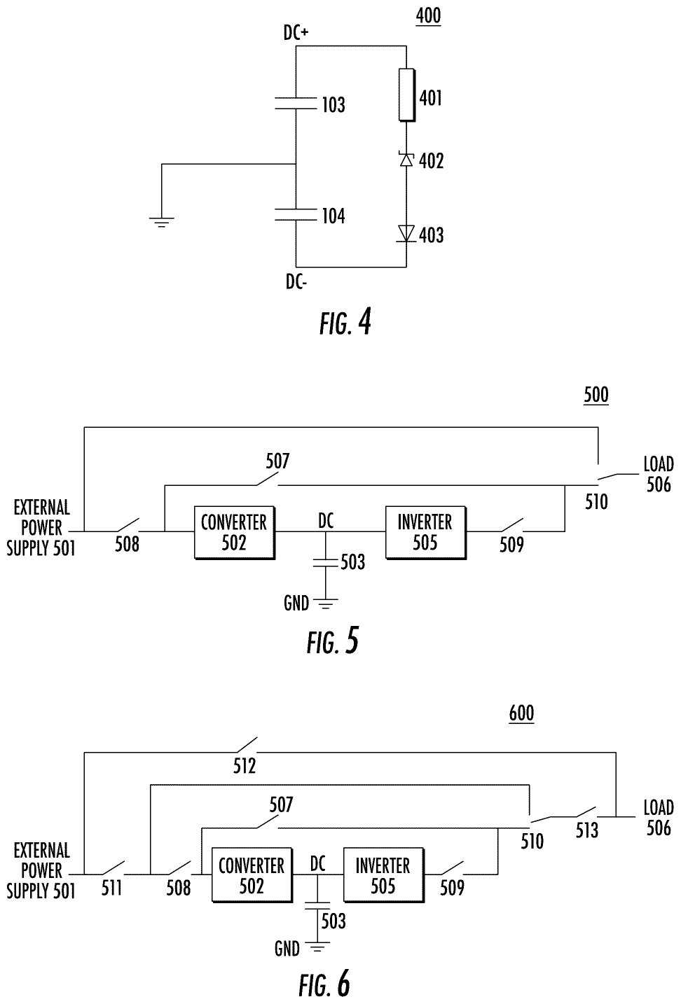

FIG. 6 shows a schematic diagram of an uninterruptible power supply according to some embodiments of the present inventive concept. Parts the same as those in FIG. 5 will be no longer repeated herein. Differences lie in that an uninterruptible power supply 600 further includes an alternative second maintenance circuit. The uninterruptible power supply 500 further includes an external input switch 511, connected between the internal input switch 508 and the external power supply 501; an external output switch 513, connected between the first maintenance switch 510 and the load 506; and a second maintenance switch 512, connected between the external power supply 501 and the load 506.

In these embodiments, when maintenance is required, the second maintenance switch 512 can be directly turned on, while the external input switch 511 and the external output switch 513 are turned off, so that a maintenance mode can be rapidly reached; and the uninterruptible power supply is rapidly powered off, so that the uninterruptible power supply is avoided from being damaged.

In these embodiments, the switch involved in the disclosure may be a relay, a circuit breaker, a mechanical switch, a semiconductor switch, etc.

The uninterruptible power supply in the disclosure includes the aforementioned energy storage circuit for an uninterruptible power supply and stores electrical energy by only using the energy storage circuit other than energy storage devices such as batteries.

In the energy storage circuit and the uninterruptible power supply provided in the disclosure, the energy storage capacitors are built in the uninterruptible power supply, and the capacitors are provided with external discharging interfaces, which facilitate maintenance. By using the energy storage circuit and the uninterruptible power supply provided in the disclosure, batteries and connecting lines of the batteries are saved, and the cost is reduced. By using the capacitors, the charging current can be greater, the charging speed can be faster, and the load can be protected better.

The energy storage circuit and the uninterruptible power supply provided in the disclosure can be applied to a three-phase uninterruptible power supply with a higher bus voltage, such as a three-phase backup uninterruptible power supply.

Although the disclosure has been described with respect to certain embodiments, the disclosure is not limited to the embodiments described herein, and further includes various alterations or changes made without departing from the scope of the disclosure.

What is claimed is:

1. An energy storage circuit for an uninterruptible power supply, comprising:
a first converter unit, connected between a positive DC bus and a ground, and used to receive an AC power from an external power supply, rectify and boost the AC power, and then supply power to the positive DC bus;
a second converter unit, connected between a negative DC bus and the ground, and used to receive the AC power from the external power supply, rectify and boost the AC power, and then supply power to the negative DC bus;
a first energy storage device, connected between the positive DC bus and the ground, and used to store electrical energy from the first converter unit;
a second energy storage device, connected between the negative DC bus and the ground, and used to store electrical energy from the second converter unit; and
an inverter for receiving electrical energy from the DC bus and inverting the electrical energy into AC power and outputting the AC power to a load;
wherein the first energy storage device and the second energy storage device each comprise a plurality of capacitors connected in parallel.

2. The energy storage circuit for an uninterruptible power supply of claim 1, wherein the capacitors are electrolytic capacitors with withstand voltage values higher than a peak value of the external power supply.

3. The energy storage circuit for an uninterruptible power supply of claim 1, wherein an overall capacity value of the first energy storage device and the second energy storage device is expressed as:
$$C > \frac{2 PT}{{U}^{2} \cdot {E}_{eff}}$$
wherein C is the overall capacity value of the first energy storage device and the second energy storage device, U is a voltage between the positive DC bus and the negative DC bus, P is an output power of the uninterruptible power supply, T is power backup time, and E_{eff} is an efficiency of the uninterruptible power supply.

4. The energy storage circuit for an uninterruptible power supply of claim 1, wherein the energy storage circuit further comprises a discharging circuit configured to discharge the first energy storage device and the second energy storage device when the uninterruptible power supply is powered off.

5. The energy storage circuit for an uninterruptible power supply of claim 4, wherein the discharging circuit comprises a first resistor, a second resistor and a switching device,
the switching device comprises a power supply end connected to an internal power supply of the uninterruptible power supply, a first switch and a second switch, the switching device is used to turn off the first switch and the second switch when the internal power supply is on a high level, and turn on the first switch and the second switch when the uninterruptible power supply is powered off and the internal power supply is reduced to be lower than a threshold; and
the positive DC bus is connected to the ground via the first resistor and the first switch, and the negative DC bus is connected to the ground via the second resistor and the second switch.

6. The energy storage circuit for an uninterruptible power supply of claim 5, wherein the switching device is a relay, a circuit breaker, a mechanical switch or a semiconductor switch.

7. The energy storage circuit for an uninterruptible power supply of claim 1, wherein the energy storage circuit further comprises a discharge completion indicating circuit for indicating that the first energy storage device and the second energy storage device complete discharge.

8. The energy storage circuit for an uninterruptible power supply of claim 7, wherein the discharge completion indicating circuit comprises a third resistor, a voltage stabilizing diode and a light emitting diode that are connected in series between the positive DC bus and the negative DC bus.

9. The energy storage circuit for an uninterruptible power supply of claim 1, wherein the first converter unit and the second converter unit each comprise a rectifying unit and a boosting unit, and the boosting unit is a flyback circuit.

10. An uninterruptible power supply, comprising the energy storage circuit for an uninterruptible power supply of claim 1, and the uninterruptible power supply storing electrical energy by only using the energy storage circuit.
